(19) United States
(12) Patent Application Publication
(10) Pub. No.: US 2006/0102700 A1
(43) Pub. Date: May 18, 2006

(54) Printed circuit board having improved solder pad layout

(75) Inventors: Ya-ling Huang, Shenzhen (CN); Di Li, Shenzhen (CN); Yu-cui He, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/025,161

(22) Filed: Dec. 29, 2004

(30) Foreign Application Priority Data
Nov. 8, 2004 (CN) 200410051104.1

(51) Int. Cl. B23K 31/02; B23K 31/00

(52) U.S. Cl. 228/180.21

(57) ABSTRACT

A printed circuit board (100) includes a plurality of through-holes (26) defined therein, and a plurality of solder pads (20) defined to surround the through holes (26) respectively. Each of the solder pads (20) includes a first soldering zone (22) for accommodating solder used in a soldering process and a second soldering zone (28) in communication with the first soldering zone (22) for receiving excess solder extravasating from the first soldering zone (22). An axis of each of the solder pads (22) and a direction opposite to a movement direction of the printed circuit board (100) in the soldering process defines a predetermined angle.

### BACKGROUND OF THE INVENTION

1. Field of the Invention

The invention is related to a printed circuit board, and more particularly to a printed circuit board which has improved solder pad layout.

2. Description of the Related Art

A typical electrical device generally comprises a printed circuit board (PCB) on which a plurality of components, such as resistors, capacitors, Dual In-line Package (DIP) components, etc., is mounted. The components are generally mounted to the printed circuit board by inserting component leads into through-holes defined in the printed circuit board, and later being soldered to the printed circuit board in a soldering process.

Nowadays, the electrical device is getting smaller, and the components inserted into the printed circuit board are getting smaller correspondingly. For such DIP components, spacing between the leads is getting narrower; especially some lead spacing is less than 1.0 millimeter. Therefore, the structure of printed circuit board must be changed to meet this situation.

Referring to FIGS. 8 and 9, these figures illustrate a typical printed circuit board 1 which is needed to be passed through a wave-soldering machine (not shown) for soldering a component 2 thereto. The component 2 comprises a plurality of leads 8, 9. A plurality of through-holes 6 is defined in the printed circuit board 1 for holding the leads 8, 9 respectively. A plurality of solder pads 3, 5 is defined in the printed circuit board 1 to surround through-holes 6 respectively. Each of the solder pads 3, 5 is circular. The leads 8, 9 of the component 2 are extended through the printed circuit board 1 via corresponding through-holes 6. Solder is applied to the solder pads 5. The printed circuit board 1 is passed through the wave-soldering machine, and excess molten solder extravasates from the solder pads 5 to form a bridge between adjacent leads 8, 9. A shorting is thus produced between the lead 8 and the lead 9, and the printed circuit board can be damaged in use due to shoring. More information relating to such technology is disclosed in U.S. Pat. No. 5,000,691 and U.S. Pat. No. 5,092,035.

Thus an improved PCB which overcome the above-mentioned problems are desired.

### SUMMARY OF THE INVENTION

Therefore, it is an object of the present invention to provide a printed circuit board which has improved solder pad layout.

To achieve the above-mentioned object, a printed circuit board in accordance with the present invention comprises a plurality of through-holes defined therein, and a plurality of solder pads defined to surround the through-holes respectively. Each of the solder pads comprises a first soldering zone for accommodating solder used in a soldering process and a second soldering zone in communication with the first soldering zone for receiving excess solder extravasating from the first soldering zone. An axis of each of the solder pad and a direction opposite to a movement direction of the printed circuit board in the soldering process defines a predetermined angle.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is an exploded, isometric view of a printed circuit board and a component according to a first embodiment of the present invention.

FIG. 2 is an enlarged view of a circled portion II of FIG. 1.

FIG. 3 is an assembled view of FIG. 1.

FIG. 4 is an isometric view of a printed circuit board according to a second embodiment of the present invention.

FIG. 5 is an isometric view of a printed circuit board according to a third embodiment of the present invention.

FIG. 6 is an isometric view of a printed circuit board according to a fourth embodiment of the present invention.

FIG. 7 is an isometric view of a printed circuit board according to a fifth embodiment of the present invention.

FIG. 8 is an exploded, isometric view of a printed circuit board and a component according to the prior art, and

FIG. 9 is an assembled view of FIG. 8.

### DESCRIPTION OF THE PRESENT INVENTION

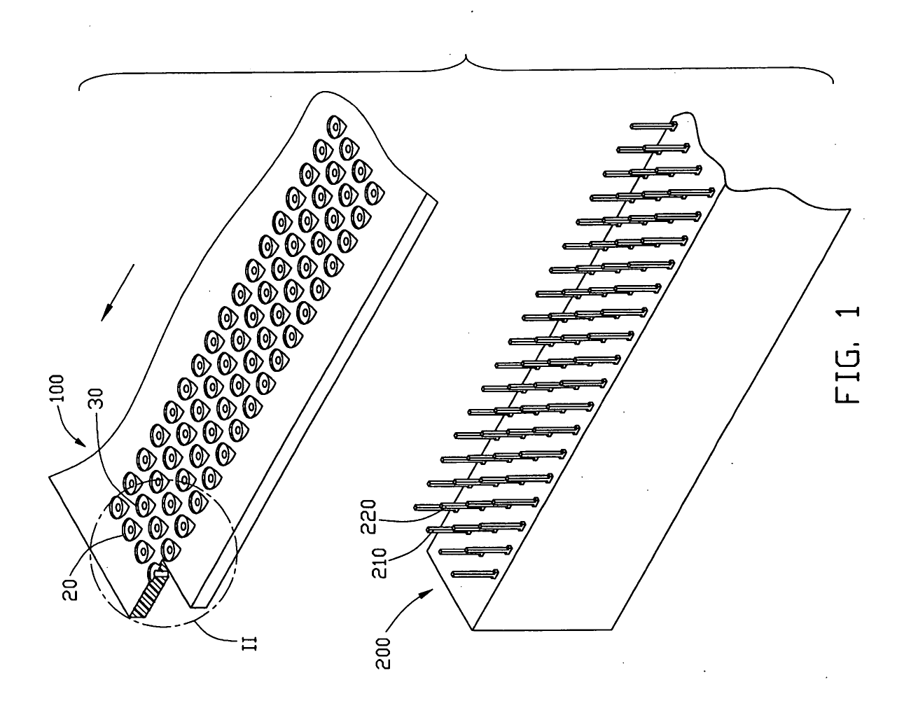

Referring to FIG. 1, the present invention provides a printed circuit board 100 having improved solder pad layout. A plurality of electrically conductive solder pads 20, 30 are defined in the printed circuit board 100 for facilitating soldering leads 210 of a component 200 to the printed circuit board 100 and preventing neighboring leads 210, 220 from electrical shorting because of bridging of excess solder extravasating from the solder pads 20, 30 formed between the neighboring lead 210 and lead 220 during a soldering process.

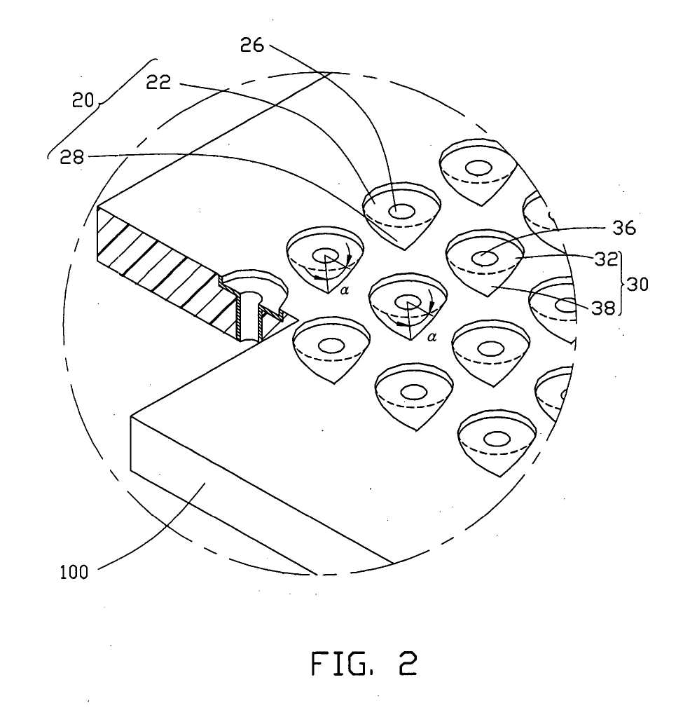

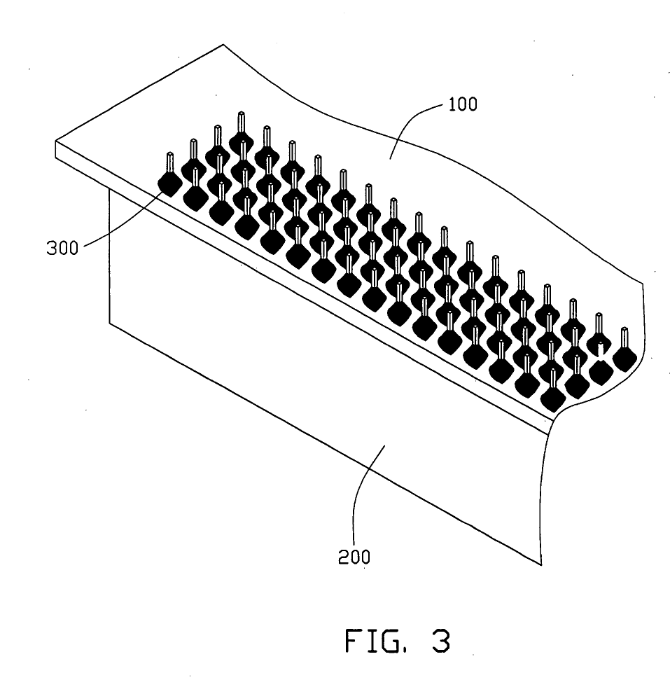

Referring also to FIGS. 2 and 3, these figures show the first embodiment according to the present invention. In FIG. 2, the printed circuit board 100 defines a plurality of through-holes 26, 36 for holding the leads 210, 220 of the component 200, and a plurality of solder pads 20, 30 surrounding the through-holes 26, 36 respectively. Each solder pad 20, 30 is tear-shaped and sunken slightly from a surface of the printed circuit board 100. Each solder pad 20 comprises a first soldering zone 22 and a second soldering zone 28 in communication with the first soldering zone 22, and the surface of the second soldering zone 28 is capable of being soldered. Each through-hole 26 is located at a middle portion of the first soldering zone 22. Each solder pad 30 comprises a first soldering zone 32 and a second soldering zone 38 in communication with the first soldering zone 32. Each through-hole 36 is located at a middle portion of the first soldering zone 32.

Assuming movement direction of the printed circuit board 100 in the wave-soldering machine (not shown) as an arrow direction shown in FIG. 1. An axis of each solder pad 20 and a direction opposite to the movement direction of the printed circuit board 100 cooperatively defines a negative angleα the angleα ranges between negative 15 degree to negative 60 degree, and negative 30 degree is preferable. An axis of each solder pad 30 and the direction opposite to the movement direction of the printed circuit board 100 cooperatively defines a negative angle equal to the negative angle α of the solder pad 20.

To solder the component 200 to the printed circuit board 100, the leads 210, 220 of the component 200 are extended through the through-holes 26, 36 of the printed circuit board 100, and solder 300 is fed to the first soldering zones 22, 32 of the solder pads 20, 30 respectively. The printed circuit board 100 with the component 200 is passed through a wave-soldering machine via a transport belt (not shown). When the printed circuit board 100 is carried to move slantingly upwardly in the wave-soldering machine, excess molten solder in the first soldering zones 22, 32 of the solder pads 20, 30 flows toward the opposite movement direction of the printed circuit board 100 because of gravity, that is, the excess molten solder flows into the second soldering zone 28, 38 of the solder pads 20, 30 respectively. In this way, it will prevent adjacent leads from being soldered together by the excess solder, so electrical shorting between adjacent leads is thus prevented. As a result, it avoids the printed circuit board 100 out of use.

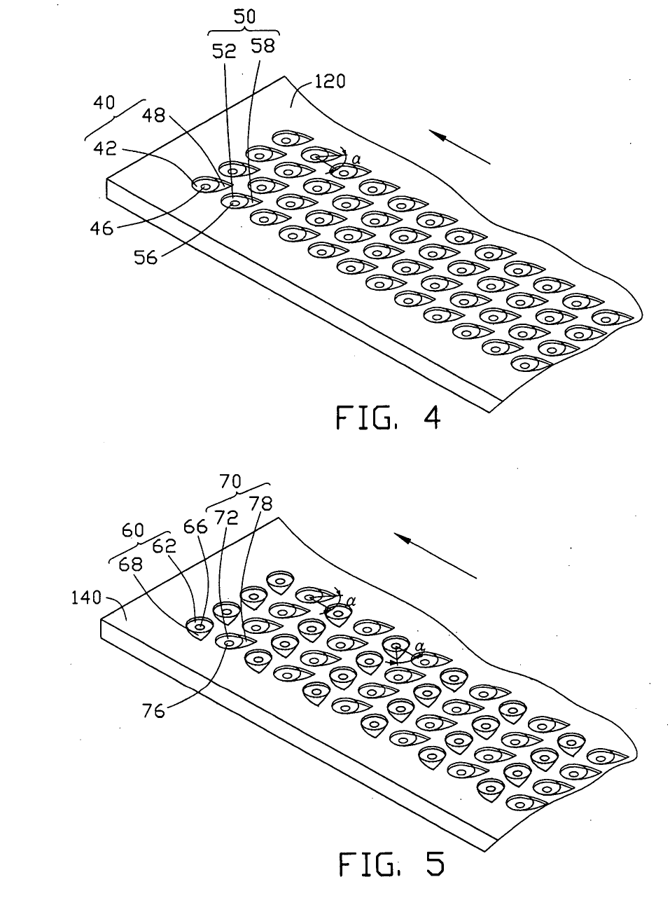

Referring to FIG. 4 shows the second embodiment according to the present invention. The printed circuit board 120 defines a plurality of through-holes 46, 56, and a plurality of solder pads 40, 50 surrounding the through-holes 46, 56 respectively. Each solder pad 40, 50 are tear-shaped and sunken slightly from a surface of the printed circuit board 120. Each solder pad 40 comprises a first soldering zone 42 and a second soldering zone 48 in communication with the first soldering zone 42, and the surface of the second soldering zone 48 is capable of being soldered. Each through-hole 46 is located at a middle portion of the first soldering zone 42. Each solder pad 50 comprises a first soldering zone 52 and a second soldering zone 58 in communication with the first soldering zone 52. Each through-hole 56 is located at a middle portion of the first soldering zone 52. An axis of each solder pad 40 and a direction opposite to the movement direction of the printed circuit board 120 cooperatively defines a positive angleα, the positive angleα ranges between positive 15 degree to positive 60 degree, and positive 30 degree is preferable.

Referring to FIG. 5, it shows the third embodiment of the present invention. The printed circuit board 140 comprises a plurality of solder pads 60, 70 respectively arranged in neighboring rows. Each solder pad 60 comprises a first soldering zone 62 and a second soldering zone 68 in communication with the first soldering zone 62. Each solder pad 70 comprises a first soldering zone 72 and a second soldering zone 78 in communication with the first soldering zone 72. An axis of each solder pad 60 and a direction opposite to the movement direction of the printed circuit board 140 cooperatively defines a negative angleα, the negative angleα ranges between negative 15 degree to negative 60 degree, and negative 30 degree is preferable. An axis of each solder pads 70 and a direction opposite to the movement direction of the printed circuit board 140 cooperatively defines a positive angleα, the positive angleα ranges between positive 15 degree to positive 60 degree, and positive 30 degree is preferable.

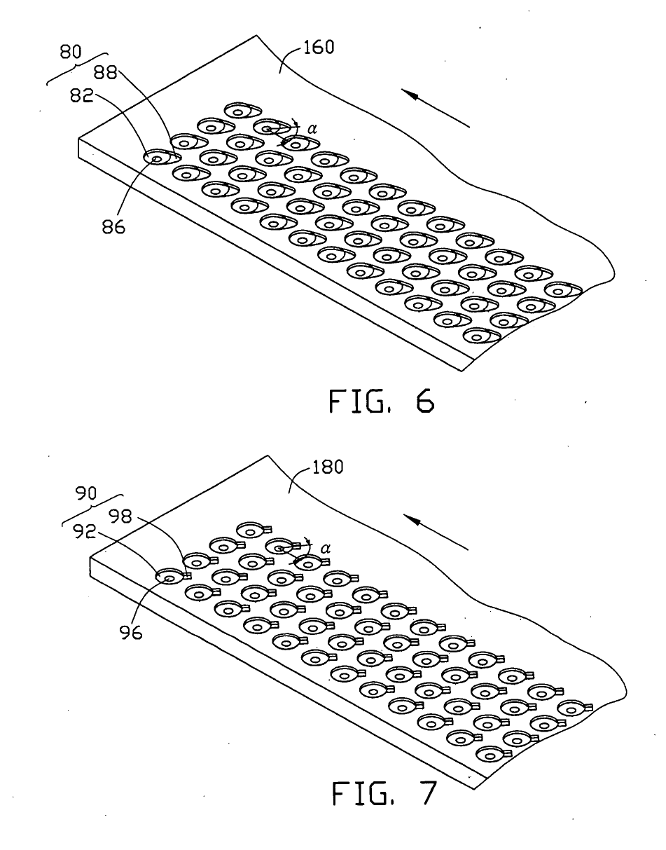

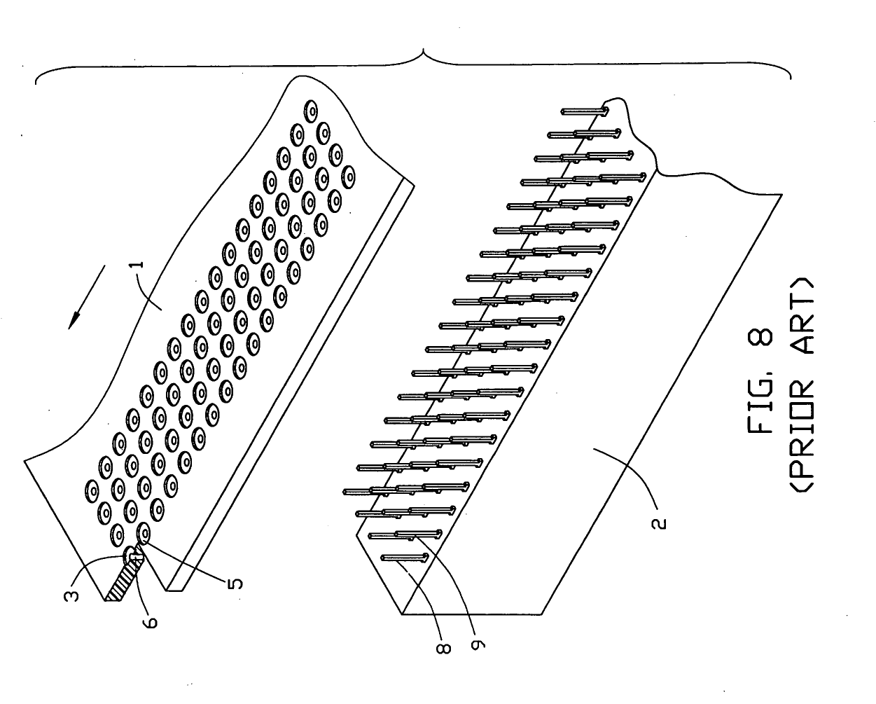

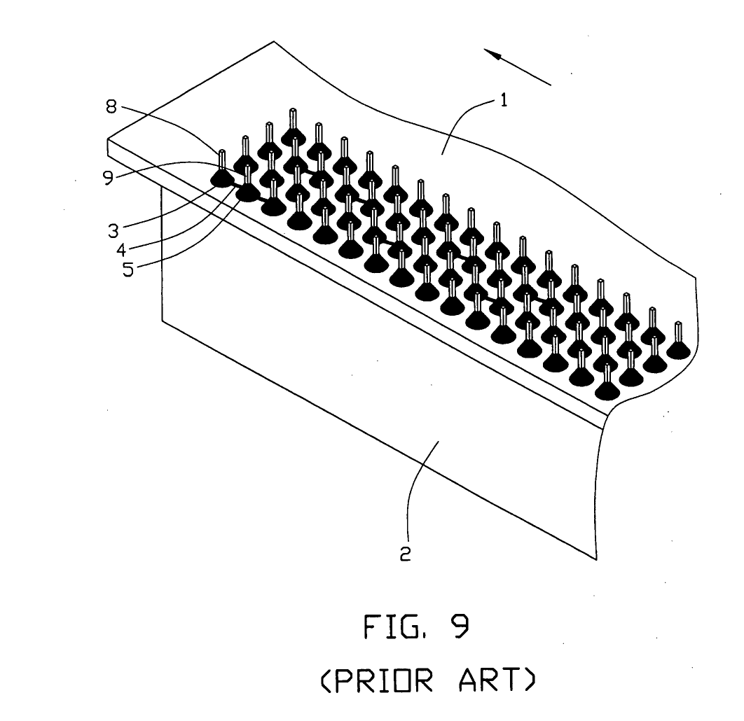

Referring to FIGS. 6 and 7, these figures show the fourth and fifth embodiment of the present invention respectively. The printed circuit board 160 and 180 defines a plurality of through-holes 86, 96, and a plurality of solder pads 80, 90 surrounding the through-holes 86, 96 respectively. In FIG. 6, each solder pad 80 is arcuate and sunken slightly from a surface of the printed circuit board 160. Each solder pad 80 comprises a first soldering zone 82 and a second soldering zone 88 in communication with the first soldering zone 82. Each through-hole 86 is located at a middle portion of the first soldering zone 82. In FIG. 7, each solder pad 90 is quadrate and sunken slightly from a surface of the printed circuit board 180. Each solder pad 90 comprises a first soldering zone 92 and a second soldering zone 98 in communication with the first soldering zone 92. Each through-hole 96 is located at a middle portion of the first soldering zone 92.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to full extent indicated by the broad general meaning of the terms in which the appended claims are expressed.

What is claimed is:

1. A printed circuit board comprising:
a plurality of through-holes defined therein, and
a plurality of solder pads defined to surround the through-holes respectively, each of the solder pads comprising a first soldering zone for accommodating solder used in a soldering process and a second soldering zone in communication with the first soldering zone for receiving excess solder extravasating from the first soldering zone.

2. The printed circuit board as claimed in claim 1, wherein an axis of each of the solder pads and a direction opposite to a movement direction of the printed circuit board in the soldering process defines a predetermined angle.

3. The printed circuit board as claimed in claim 2, wherein each of the solder pads defines a same angle ranging from positive or negative 15 degree to positive or negative 60 degree.

4. The printed circuit board as claimed in claim 2, wherein the solder pads are arranged in rows, each of the solder pads arranged in one row defines a same first angle, and each of the solder pads arranged in another row neighboring to said row defines a same second angle different from the first angle.

5. The printed circuit board as claimed in claim 1, wherein the second soldering zone of each of the solder pads is tear-shaped.

6. The printed circuit board as claimed in claim 1, wherein the second soldering zone of each of the solder pads is arcuate.

7. The printed circuit board as claimed in claim 1, wherein the second soldering zone of each of the solder pads is quadrate.

8. The printed circuit board as claimed in claim 1, wherein each of the through-holes is located at a middle portion of a corresponding first soldering zone.

9. A printed circuit board comprising:
a plurality of components each having two leads to be soldered to an surface of the printed circuit board;
a plurality of solder pads defined therein corresponding to the leads of the components;
wherein each of the solder pad is capable of holding excess solder therein to prevent extravasating in a soldering process.

10. The printed circuit board as claimed in claim 9, wherein each of the solder pads comprising a first soldering zone to accommodate the solder and a second soldering zone in communication with the first soldering zone to receive excess solder.

11. The printed circuit board as claimed in claim 10, wherein an axis of each of the solder pads and a direction opposite to a movement direction of the printed circuit board in the soldering process defines a predetermined angle.

12. The printed circuit board as claimed in claim 11, wherein each of the solder pads defines a same angle ranging from positive or negative 15 degree to positive or negative 60 degree.

13. A method for control of flowable solder on a circuit board, comprising the steps of: providing a plurality of electrically conductive pads formed on said circuit board;
placing said flowable solder onto each of said plurality of pads; and
forming a solder-receivable zone neighboring said each of said plurality of pads so as to receive said flowable solder and limit movement of said flowable solder out of said each of said plurality of pads and said neighboring zone in case that said circuit board moves to drive said movement of said flowable solder.

14. The method as claimed in claim 13, wherein said neighboring zone continuously extends from said each of said plurality of pads so as to communicate with another solder-receivable zone formed in said each of said plurality of pads.

15. The method as claimed in claim 13, wherein said neighboring zone extends from said each of said plurality of pads along a direction having an included angle less than 90 degree with a moving direction of said circuit board.

16. The method as claimed in claim 13, wherein said plurality of pads is arranged as an array, and said neighboring zone extends from one pad in one line of said array along a direction different from another pad in another line of said array neighboring said line of said array.
